(19) United States
(12) Patent Application Publication
(10) Pub. No.: US 2014/0284975 A1
(43) Pub. Date: Sep. 25, 2014

(54) Talking Car Seat

(71) Applicant: Maria Nelly Manimbo, Anaheim, CA (US)

(72) Inventor: Maria Nelly Manimbo, Anaheim, CA (US)

(21) Appl. No.: 13/848,033

(22) Filed: Mar. 20, 2013

(51) Int. Cl. G08B 21/02; B60N 2/00; B60N 2/26

(52) U.S. Cl. CPC G08B 21/02; B60N 2/26; B60N 2/002
USPC 297/217.4; 340/457

(57) ABSTRACT

The invention provides an audible security system incorporated in an infant car seat. The Talking Car Seat is a fully functioning vehicle safety seat which comprises an integrated alarm system that provides an audible alert when a parent restrains a child improperly or when a parent fails to remove a child from the Talking Car Seat after parking their vehicle.

### CLAIM OF PRIORITY

This patent application claims priority under 35 USC 119 (e) (1) from U.S. Provisional Patent Application Ser. No. 61/685,558 filed Mar. 20, 2012, of common inventorship herewith entitled, “Talking Car Seat.”

### FIELD OF THE INVENTION

The present invention pertains to the field of infant and child supplies, and more specifically to the field of infant and child car seats.

### BACKGROUND OF THE INVENTION

The prior art has put forth several designs for infant seats. Among these are:

U.S. Pat. No. 5,581,234 to Anna L. Emery and David P. Emery describes an infant vehicle seat alarm system designed to produce an audible or visual warning when the seat or carrier component is aligned on the base component but not solidly locked onto the base component or when the harness is in an unused state. The alarm system has a main circuit which includes a power source, an audible or visual alarm, a main switch, and two double pole switches all connected together in a series. The double pole switches are used to close the main circuit or connect it with a branching circuit thereto. The main circuit detects the presence of the carrier component aligned on the base component. Two double pole switches are disposed between the carrier component and the base component which are moved between the two contact positions by the carrying handle when rotated between unlocked and locked positions. The branching circuit includes a normally closed single pole switch located in the buckle of the harness. When the seat component is properly aligned and locked on the base component, the alarm is activated when the clip is disconnected from the buckle.

U.S. Pat. No. 6,809,640 to Robyn Ann Sherman describes a harness safety alarm system for providing a warning in the event a seat belt is uncoupled. This alarm system comprises a proximity sensor connected by strap to a seat belt buckle. A detectable means such as a magnet is attached by strap to a tongue of the seat belt. A warning unit mounted remotely from the proximity sensor provides an audible and visual warning if the seat belt is uncoupled. If a seat belt is uncoupled, a sensing means sends a radio frequency signal to a warning unit and activates an audible and visual warning.

U.S. Pat. No. 7,466,221 to Scott K. Lehr describes a warning system for a child restraint system. The child restraint system includes a base and a seat connected to the base. The seat includes supports for the back, torso, right leg and left leg. The seat includes sensors to detect the presence of a back, torso, right leg and left leg respectively. The seat also includes a right harness strap and a left harness strap that connects to a child seat buckle and a chest clip. The seat has a locking clip with a tether strap having a hook. The seat contains detectors to determine whether straps, buckles and straps are properly connected while an infant or child is present in the seat. If connected improperly, a distinct alarm sounds.

None of these prior art references describe the present invention.

### SUMMARY OF THE INVENTION

It is an object of the present invention to provide a talking car seat with safety status and instructional alerts.

### BRIEF DESCRIPTION OF THE DRAWINGS

FIG. 1 is a prototypical front view showing an unoccupied infant car seat with a carry handle and a seat belt.

FIG. 2 is a prototypical side view showing an unoccupied infant car seat with a carry handle and a weight sensor.

FIG. 3 is a prototypical close up view showing an unoccupied infant car seat with a seat belt sensor and messages that emanate audibly in reference to seat belt status such as Buckle Me UP!, Seat Belt ON, and Seat Belt OFF!

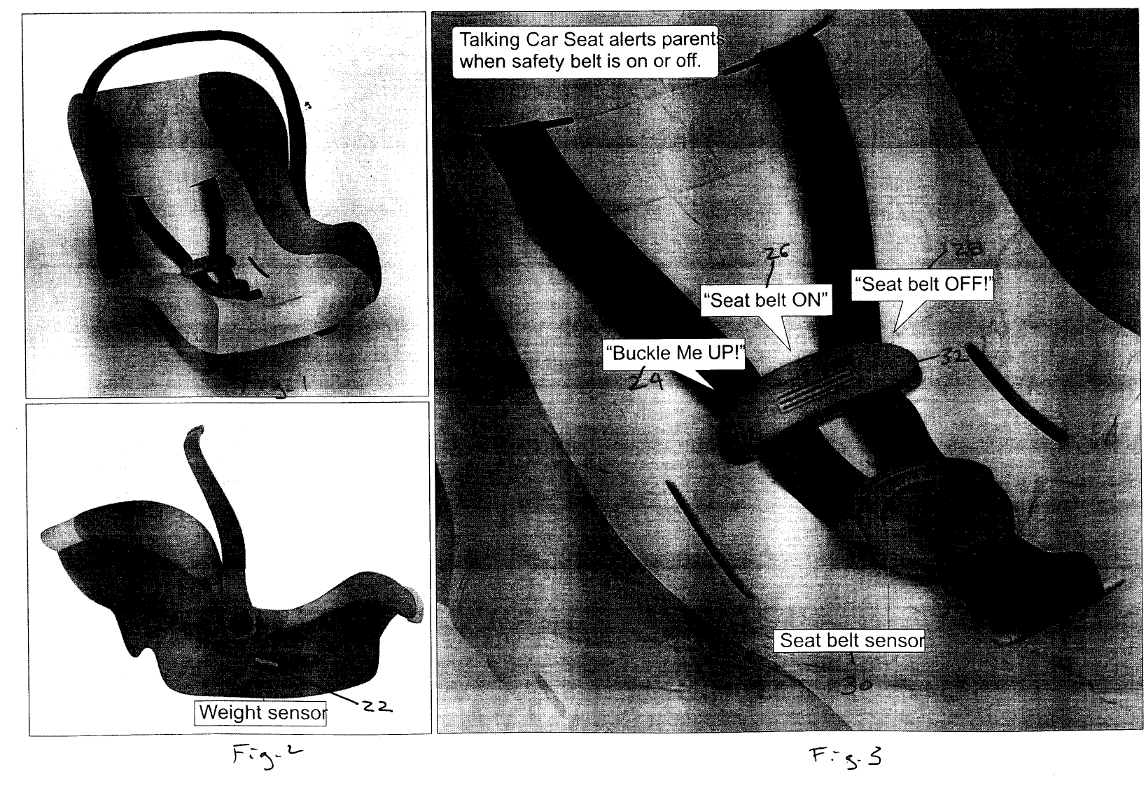

### DETAILED DESCRIPTION OF THE INVENTION

One of the most practical and necessary infant accessories used by parents and caregivers is a simple car seat. Used from the time of birth through the toddler years and beyond, car seats are extremely useful devices which provide a comfortable and secure place for a child to sit while traveling in a vehicle. A car seat is an invaluable safety tool designed specifically to fully restrain a child if an automobile collision occurs. Correctly installed and used, infant car seats have proven to save lives. Mandated by law in most states, a car seat may mean the difference between life and death for children involved in car accidents. For optimal safety, car seats are used from a child's time of birth until approximately four years old or forty pounds in weight. Then a transitional child booster seat is employed. Carrier style car seats most often are utilized with newborn and young infants. These reclining cradle seats typically are utilized from time of birth until a child is approximately six months old or twenty two pounds at which point a child usually has developed enough strength to sit upright in an upright car seat. An upright car seat typically is utilized through the toddler years until a child has reached a weight of approximately forty pounds. While most consumers agree that car seats are a practical necessity, car seats have a few drawbacks. On hectic and busy days, a parent or caregiver may become preoccupied and may inadvertently forget to buckle the seat belt after placing their within a car seat. Their child may climb out of the seat or be thrown from the seat upon a quick braking or collision. Rushing from work to collect children from school or day care, a parent may have to complete a plethora of other errands before finally reaching home, such as making a bank deposit or picking up a few items from the market for dinner. A parent may consider it safe to leave a child in the car while quickly dashing into an establishment, or they may unthinkingly leave a child behind. A child being left alone in a car can lead to tragic circumstances especially on hot days. On a mild day of approximately seventy three degrees outside, a vehicle heats to approximately one hundred degrees in approximately ten minutes and to approximately one hundred twenty degrees in approximately thirty minutes. As outdoor temperature rises, so does the heat buildup in a vehicle. At approximately ninety degrees outside, a vehicle's interior of a vehicle heats up to approximately one hundred sixty degrees within several minutes. Children's developing respiratory system makes them particularly vulnerable to heat exhaustion. As heat temperature rises, their body temperatures rise. Infants approach the temperature of their environment very rapidly, and tragic fatalities result from children being left alone in motor vehicles.

The present invention, hereinafter referred to as the Talking Car Seat, is an audible security system incorporated in an infant car seat. The Talking Car Seat is a fully functioning vehicle safety seat which comprises an integrated alarm system that provides an audible alert when a parent restrains a child improperly or when a parent fails to remove a child from the Talking Car Seat after parking their vehicle. Similar in appearance, design and function to a standard convertible style car seat, one embodiment of the Talking Car Seat is an upright bucket style safety seat designed to be utilized by newborns and infants up to forty pounds in weight. A second embodiment of the present invention is a transitional version for young children up to eighty pounds. Manufactured of heavy duty plastic material with durable stainless steel components, the Talking Car Seat comprises a cushiony soft padded liner which generously covers the interior of the unit. This removable and machine washable liner secures to the seat with a series of elastic closures spaced evenly around an outer edge of the liner and attached to plastic hooks that are integrated into the back of the seat. The Talking Car Seat contains a three point harness, a three point harness with a shield or a five point harness which functions to restrain a child. The Talking Car Seat is installed in a vehicle's back seat by one of two means, either a latch installation for newer vehicles or a safety belt installation for older vehicles. The vehicle's shoulder harness runs through rectangular shaped grooves positioned on either arm rest of the seat. The vehicle's lap belt runs through an elongated oval shaped opening located on the back base of the seat. The shoulder harness and lap belt are buckled into corresponding latches or safety belts. After installation, an integrated alarm system within the infant seat is activated. Internally contained within the seat and backrest is an integrated weight sensor mechanism 22 which detects that a child has been placed within the seat. This weight bearing sensor 22 is connected to an audible alarm which emits a recorded message from speaker 32 of “Buckle Me Up” 24 when a child is placed within the car seat. Emitted and sounding like a human voice, this directive is repeated until a parent solidly engages a seat's safety harness and buckle. When the seat belt and harness are properly engaged, the seat belt sensor 30 emits a message of “Seat Belt On” 26 is emitted, alerting a parent that their child is properly restrained. If the seat belt buckle is released or not solidly engaged, a message of “Seat Belt Off” 28 is emitted from speaker 32. A second remote sensor determines when a vehicle is parked and turned off, and with a simple alarm or spoken message, alerts a parent to remove the child from the car seat. The Talking Car Seat is powered by an internally contained rechargeable battery power back located within the seat. The Talking Car Seat also may run on battery power supplied by a vehicle battery and connected to a seat base by using a standard adapter plug.

Application and use of the Talking Car Seat is simple and straight forward. Depending on vehicle accommodation, a user purchases a Talking Car Seat with either a latch installation system or a safety belt installation system. Following package instructions, a user then installs the Talking Car Seat within their back seat. Once the Talking Car Seat is installed safely within the vehicle, a user places their infant within the seat, automatically activating an integrated weight sensor which activates an alarm that emits Buckle Me Up and repeats until the child is restrained safely within the seat. After parking and turning off the vehicle, the Talking Car Seat then emits an audible alarm to alert the caregiver to remove their child from the car seat. After use, the Talking Car Seat is left in place within the car until needed again. The present invention effectively prevents rushed and harried parents from unintentionally leaving a child unbuckled in their car seat or even leaving behind a helpless child in a car. The Talking Car Seat detects an occupant's weight in a matter of seconds, emitting an audible alert when a child is placed in a seat. Such alerts are clear audible reminders to secure the seat's safety harness or remove a child from a parked vehicle immediately. Incorporated into the design of a car seat, the Talking Car Seat is installed easily in any type of vehicle in a secure and stable manner. The integrated harness system meets required safety specifications and safely restrains an infant or child at all times. Comfortably restricting a child's movements, the Talking Car Seat prevents a child from being jolted or thrown from the seat in case of sudden stops or an automobile collision. The present invention is a highly functioning and effective infant and toddler car seat to be utilized by parents, grandparents, nannies, childcare providers and professional caregivers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A talking car seat device with audible safety status and instructional alerts, comprising: an audible integrated security alarm system incorporated in an infant car seat that emits an audible alert.

2. The talking car seat device of claim 1 wherein the audible alert is emitted when a parent restrains a child improperly or when a parent fails to remove a child from the talking car seat after parking a vehicle.

3. The talking car seat device of claim 1 comprising an upright bucket style safety seat designed to be utilized by newborns and infants up to forty pounds in weight.

4. The talking car seat device of claim 1 comprising a transitional booster seat version for young children up to eighty pounds.

5. The talking car seat device of claim 1 comprising heavy duty plastic material with durable stainless steel components, comprising a removable and machine washable cushiony soft padded liner which liner covers the interior of the car seat, wherein the liner secures to the seat with elastic closures spaced evenly around an outer edge of the liner and attached to plastic hooks that are integrated into the back of the seat.

6. The talking car seat device of claim 5, wherein the seat comprises a three point harness, or a three point harness with a shield or a five point harness.

7. The talking car seat device of claim 6 installed in the back seat of a vehicle and wherein after installation, an integrated alarm system within the infant seat is activated, and further comprising an integrated weight sensor mechanism which detects that a child has been placed within the seat, wherein the weight sensor is internally contained within the seat and backrest, and wherein the weight sensor is connected to an audible alarm which emits a recorded message of “Buckle Me Up” when a child is placed within the car seat, and wherein the message sounds like a human voice and is repeated until the child is secured in the seat.

8. The talking car seat device of claim 7 that further emits a message of “Seat Belt On” after the seat belt and harness are properly engaged.

9. The talking car seat device of claim 8 that further emits a message of “Seat Belt Off” if the seat belt buckle is released or not solidly engaged.

10. The talking car seat device of claim 8, that further comprises a second remote sensor to determine when a vehicle is parked and turned off, and alerts a driver to remove the child from the car seat.

11. The talking car seat device of claim 1 wherein the audible alert and sensors are powered by an internally contained rechargeable battery power back located within the seat.

12. The talking car seat of claim 1 wherein the audible alert and sensors are powered by a battery power supplied by a vehicle battery and connected to a seat base by using a standard adapter plug or USB plug.
